(19) United States
(12) Patent Application Publication
(10) Pub. No.: US 2023/0370621 A1
(43) Pub. Date: Nov. 16, 2023

(54) COLOR ENCODINGS BASED ON PRINTER GAMUTS

(71) Applicant: HEWLETT-PACKARD DEVELOPMENT COMPANY, L.P., Spring, TX (US)

(72) Inventors: David M. BERFANGER, Vancouver, WA (US); Di Yuan TZENG, Boise, ID (US); Jay S. GONDEK, Vancouver, WA (US); Mark Quentin SHAW, Boise, ID (US)

(21) Appl. No.: 17/740,708

(22) Filed: May 10, 2022

(51) Int. Cl. H04N 19/186; H04N 1/60

(52) U.S. Cl. CPC H04N 19/186; H04N 1/6008

(57) ABSTRACT

An example non-transitory machine-readable medium includes instructions that, when executed by a processor, cause the processor to define a color encoding based on selected colors within a reference color space. The selected colors include white, black, and a set of chromatic colors spanning different print gamuts of a range of different printing devices. The instructions are further to encode a source datapoint of a source color space with the color encoding to obtain a reference datapoint of the reference color space by determining the reference datapoint as a mixture of white, black, and two colors selected from the set of chromatic colors, and output the reference datapoint.

### BACKGROUND

Use of color in media helps convey information. Numerous forms of media, such as digital images and printed media, rely on various techniques to render color, and accurate color rendering may enhance communication.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 is a block diagram of an example non-transitory machine-readable medium that includes processor-executable instructions that define a color encoding based on selected colors to span a combined print gamut of a range of different printing devices, showing encoding of a source datapoint to a reference datapoint.

FIG. 2 is a color plot of the example color encoding with the combined print gamut of FIG. 1, as viewed perpendicular to the a*-b* plane.

FIG. 3 is a color plot of the example color encoding with the combined print gamut of FIG. 1 in an orthographic projection with viewing angles of azimuth=−30° and elevation=15°, where the angle between the L* axis and the viewer is 75°.

FIGS. 4A-4F are diagrams of example tetrahedra defined by white, black, and selected primary and secondary colors of the set of chromatic colors of the color encoding of FIG. 1.

FIG. 5 is a flowchart of an example method to encode a source datapoint to obtain a reference datapoint with a color encoding that is based on selected colors including white, black, and a set of chromatic colors spanning a combined print gamut of a range of different printing devices.

FIG. 6 is a block diagram of an example non-transitory machine-readable medium that includes processor-executable instructions that define a color encoding based on selected colors to span a combined print gamut of a range of different printing devices, showing encoding of a reference datapoint to an output datapoint.

FIG. 7 is a flowchart of an example method to encode a reference datapoint to obtain an output datapoint with a color encoding that is based on selected colors including white, black, and a set of chromatic colors spanning a combined print gamut of a range of different printing devices.

FIG. 8 is block diagram of an example computing device that includes a processor to apply a color encoding based on selected colors that span a combined print gamut of a range of different printing devices.

FIG. 9 is block diagram of an example printing device to receive encoded datapoints and a corresponding color encoding based on selected colors that span a combined print gamut of a range of different printing devices.

### DETAILED DESCRIPTION

Color inconsistency in printed media may occur for various reasons. In some examples, a creator of digital images may use printers from different vendors, who may implement custom or proprietary color reproducing techniques. An image printed with one printer may appear different from the same image printed to the same type of medium by another printer. While some users and color experts may be able to configure their imaging and printing workflows to reduce color inconsistency, this often requires training. A significant set of creators, such as office workers and home users, are not trained in color and thus rely on their printers to reproduce color consistently. In addition, a given creator, whether trained in color or not, may use different printers, such as a home printer and an office printer, and may expect consistent color reproduction without undue manual effort.

Printer manufacturers have a significant degree of latitude in mapping common digital color spaces, such as Standard Red Green Blue (sRGB), to the color reproduction capabilities (i.e., gamut) of their printers. For example, a cyan-magenta-yellow-black (CMYK) printer gamut may have a narrower range of colors compare to the sRGB color space. As such, the printer manufacturer typically uses their experience and judgment to map sRGB colors not able to be reproduced by the printer (out of gamut) to CMYK colors that are reproducible by the printer (in gamut).

The techniques described herein aim to supplement or replace subjective human judgment in mapping digital image color to printer gamut with a rules-based approach that reduces or eliminates color inconsistency among different printing devices. The techniques described herein include a color encoding that is consistent with widely used RGB workflows and that provides a workspace that is shaped to fit a range of printer gamuts, so that creators may avoid using complicated workflows and relying on printer manufacturers' subjective color reproduction choices.

The techniques described herein provide a color encoding and related transforms including a forward transform and a reverse transform. The color encoding may be used to encode datapoints, such as image pixel data, within a color space. Such datapoints and color space may be referred to as source or output datapoints and color space, which are distinguished herein from reference datapoints and color space. The source/output datapoints and color space may be described as RGB triplets. The reference datapoints and color space may be described in terms of an accepted reference standard, such as CIELAB as defined by the International Commission on Illumination.

The forward transform transforms a color encoding for a source datapoint of the source color space (e.g., an RGB triplet) into a corresponding reference datapoint of a reference color space (e.g., L*a*b* coordinates).

The reverse transform transforms a reference datapoint of the reference color space (e.g., L*a*b* coordinates) into a corresponding color encoding of an output datapoint of the output color space (e.g., an RGB triplet).

Both transforms use selected colors within the reference color space. An example set of selected colors is white, black, and a set of chromatic colors spanning different print gamuts of a range of different printing devices. Example chromatic colors include red, green, blue, cyan, magenta, and yellow. In a further example, as will be discussed in detail below, the selected colors number eight and are white, black, red, green, blue, cyan, magenta, and yellow.

The selected colors may define a polyhedron within the reference color space and may be selected to fit each face of the polyhedron to a corresponding apparent surface of the combined print gamut of the range of different printing devices, such as different models of printers made by different manufacturers. The combined print gamut may be empirically determined, such as by printing an image to different types of media (e.g., matte paper, glossy paper, etc.) with different marking agents (e.g., inks, toners, etc.) using different printers, measuring the resulting color under controlled conditions (e.g., with a spectrophotometer), and combining these measurements into a combined gamut. The combined gamut may be a field of discrete colors that may be reproducible by at least one of the printers in the range. As such, the selected colors may closely represent in RGB terms actual capabilities of a range of different printing devices that a creator could be expected to use.

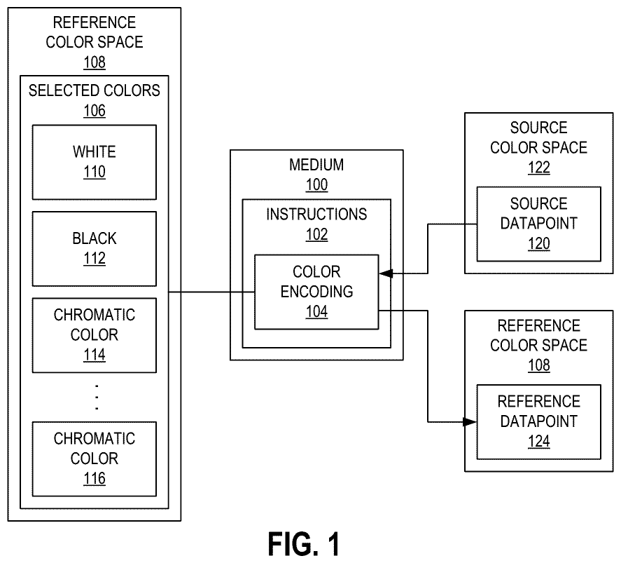

FIG. 1 shows an example non-transitory machine-readable medium 100 including processor-executable instructions 102 that define a color encoding 104 based on selected colors 106 within a reference color space 108.

The non-transitory machine-readable medium 100 may be provided to a computing device, such as a desktop computer, notebook computer, All-in-One (AiO) computer, server, tablet computer, smartphone, or the like.

The medium 100 may include a non-volatile memory, such as read-only memory (ROM), electrically-erasable programmable read-only memory (EEPROM), or flash memory. The non-transitory machine-readable medium 100 may include volatile memory, such as a random-access memory (RAM). The non-transitory machine-readable medium 100 may include an electronic, magnetic, optical, or other physical storage device that encodes the instructions 102 that implement the functionality discussed herein.

A processor that executes the instructions 102 may include a microcontroller, a central processing unit (CPU), a field-programmable gate array (FPGA), an application-specific integrated circuit (ASIC), or a similar processing device.

The instructions 102 may be directly executable, such as binary or machine code, and/or may include interpretable code, bytecode, source code, or similar instructions that may undergo additional processing to be executed. All of such examples may be considered executable instructions.

The selected colors 106 may include white 110, black 112, and a set of chromatic colors 114, 116. The chromatic colors 114, 116 number two or more, for example, six. The selected colors 106 are specifically chosen to span different print gamuts of a range of different printing devices.

The instructions 102 encode a source datapoint 120 of a source color space 122 with the color encoding 104 to obtain a reference datapoint 124 of the reference color space 108 by determining the reference datapoint 124 as a mixture of white 110, black 112, and two colors selected from the set of chromatic colors 114, 116. Encoding from the source color space 122 to the reference color space 108 may be considered a forward transform.

The source color space 122 may be a display device color space, such as an RGB color space. The source datapoint 120 may be encoded as a red, green, and blue triplet with values, for example, from 0 to 255. Any number of source datapoints 120 may be encoded. A source datapoint 120 may represent a pixel in a digital image that includes thousands, millions, or more pixels.

The reference color space 108 may be a CIELAB color space or other widely accepted standard color space. In other examples, the reference color space 108 may be a proprietary or ad hoc color space. The reference datapoint 124 may be encoded as a triplet of lightness value, L*, and two opponent color values, a* and b*. Lightness L* may range from 0 to 100 to respectively represent black 112 and white 110. The a* axis represents green-red opponents, where negative values are green and positive values are red. The b* axis represents blue-yellow opponents, with negative values being blue and positive values being yellow. The a* and b* axes are theoretically unbounded but may be limited to specific ranges, such as −128 to 127, for implementation purposes.

The instructions 102 output the reference datapoint 124. The reference datapoint 124 may represent a pixel in a digital image, which may be outputted as an array of such reference datapoints 124.

The color encoding 104 may be defined with regard to a reference viewing environment. In various examples, a reference viewing environment is defined as follows: a luminance level for observer adaptive white is 350 lux (111.4 candela per square meter or cd/m²), the observer adaptive white point has chromaticity values of CIE D50 (x=0.3456, y=0.3583), and the viewing surround is average.

The color encoding 104 and its selected colors 106 may be defined according to Table 1 or 2.

TABLE 1
Selected Colors as 16-bit Integer CIELAB Components

| Selected | CIELAB (16 Bit) | | |
|---|---|---|---|
| Color | L* | a* | b* |
| Black (K) | 2056 | 0 | 0 |
| Red (R) | 33796 | 24672 | 18651 |
| Green (G) | 33796 | −24672 | 9325 |
| Yellow (Y) | 65535 | −3525 | 32639 |
| Blue (B) | 13958 | 10574 | −21588 |
| Magenta (M) | 29828 | 24672 | −9252 |
| Cyan (C) | 41730 | −17623 | −15420 |
| White (W) | 65535 | 0 | 0 |

TABLE 2
Selected Colors as Floating-Point CIELAB Components

| Selected | CIELAB (Floating Point) | | | | |
|---|---|---|---|---|---|
| Color | L* | a* | b* | C* | h° |
| Black (K) | 3.1373 | 0.0000 | 0.0000 | 0.0000 | — |
| Red (R) | 51.5694 | 96.0000 | 72.5720 | 120.3441 | 37.0878 |
| Green (G) | 51.5694 | −96.0000 | 36.2840 | 102.6281 | 159.2955 |
| Yellow (Y) | 100.0000 | −13.7160 | 127.0000 | 127.7385 | 96.1640 |
| Blue (B) | 21.2985 | 41.1440 | −84.0000 | 93.5352 | 296.0960 |
| Magenta (M) | 45.5146 | 96.0000 | −36.0000 | 102.5280 | 339.4440 |
| Cyan (C) | 63.6759 | −68.5720 | −60.0000 | 91.1160 | 221.1857 |
| White (W) | 100.0000 | 0.0000 | 0.0000 | 0.0000 | — |

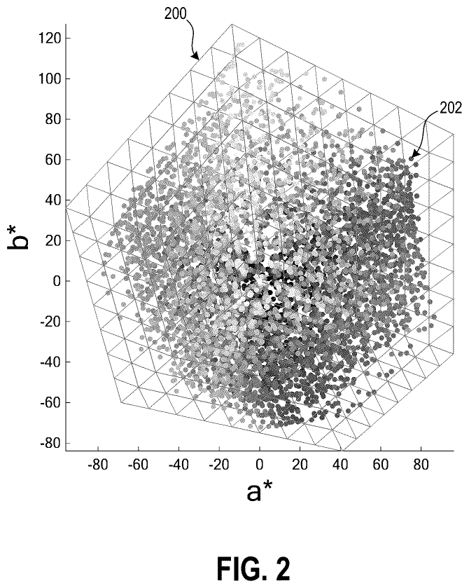

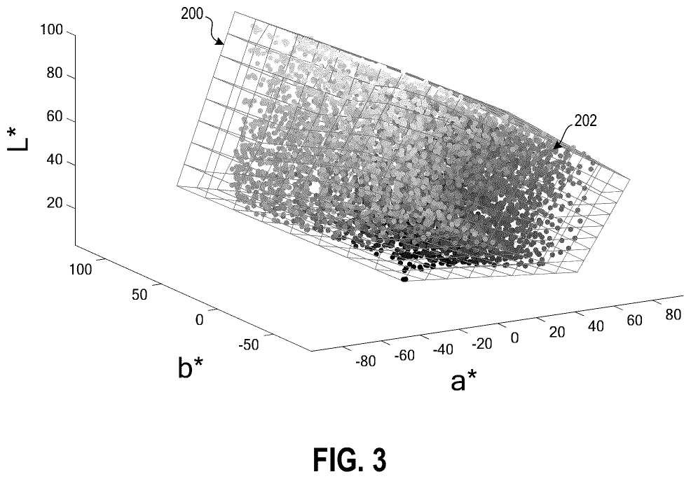

FIGS. 2 and 3 show example CIELAB plots showing the gamut 200 (mesh) of the color encoding 104, as expressed in Table 2, in the context of a combined gamut 202 (discrete color points) of a range of different printing devices. The gamut 200 of the color encoding 104 encompasses and fits the combined gamut 202 of a range of different printing devices. As can be seen, the selected colors 106 define vertices of a polyhedron that shapes gamut 200, and the selected colors 106 are chosen so that the faces of the polyhedron fit the combined print gamut 202. That is, the selected colors 106 may be selected to position each face of the polyhedron of the color-encoding gamut 200 adjacent to a corresponding apparent surface of the combined print gamut 202.

Fitting the gamut 200 of the color encoding 104 to the combined print gamut 202 may include having an outermost point in the print gamut 202 lie within a planar face of the color encoding gamut 200. In other examples, an outermost point in the print gamut 202 may be a relatively small distance from the corresponding a planar face of the color encoding gamut 200, such as 2%, 4%, 8%, or 10% of the overall width of the print gamut 202. In various examples, the planar face of the color encoding gamut 200 may be spaced one print-gamut point away from an outermost point of the print gamut 202, which may reduce errors in interpolation near the surface of the color encoding gamut 200.

In various examples, white 100 may be defined as ideal reflective white and black 112 may be defined as having 5% of the reflectance of ideal white. The positions of the chromatic colors 114, 116 may be selected such that they closely enclose the point cloud that is the combined print gamut 202. White 110, black 112, and the chromatic colors 114, 116 may be set to exact values in the combined print gamut 202 to avoid unnecessary color mixing by a printer when pure white 110, black 112, or a chromatic color 114, 116 is desired. Note that the L* value of yellow was selected to be 100 based on testing.

With reference to FIG. 1, the forward transform may convert an RGB source datapoint 120 to a respective L*a*b* reference datapoint 124 using linear interpolation as follows.

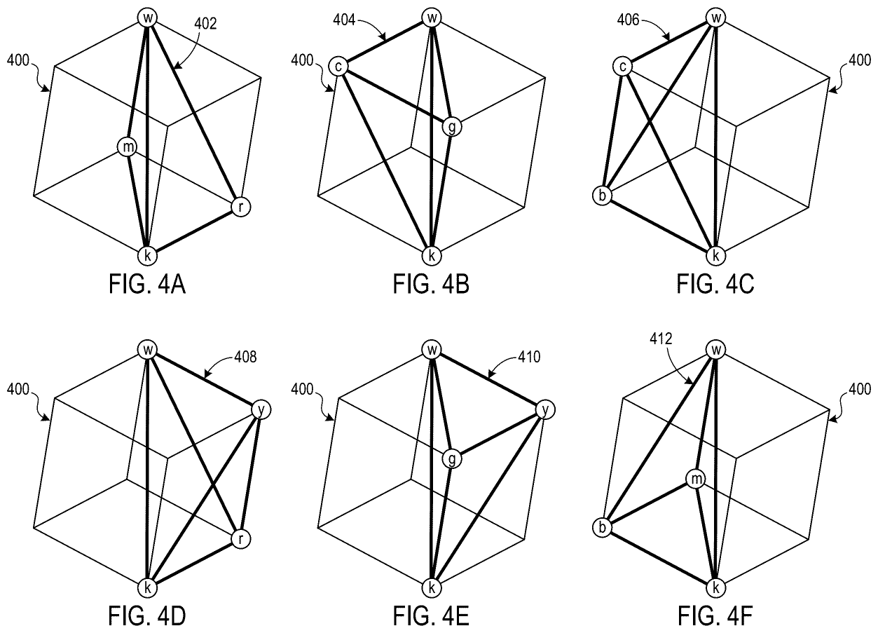

Interpolation may use four of the selected colors 106 including white 110, black 112, a primary chromatic color, and a secondary chromatic color. The chromatic colors 114, 116 may be selected to include red, green, and blue as primary chromatic colors and cyan, magenta, and yellow as secondary chromatic colors. In such examples, there are six possible unique color selections of primary color, secondary color, white, and black, as shown in FIG. 4A-4F.

FIG. 4A shows the selection of red (r) and magenta (m) which, together with white (w) and black (k), define vertices of a tetrahedron 402 within a hexahedron 400 defined by all the selected colors 106. FIG. 4B shows the selection of green (g) and cyan (c) which, together with white (w) and black (k), define vertices of a tetrahedron 404 within the hexahedron 400 defined by all the selected colors 106. FIG. 4C shows the selection of blue (b) and cyan (c) which, together with white (w) and black (k), define vertices of a tetrahedron 406 within the hexahedron 400 defined by all the selected colors 106. FIG. 4D shows the selection of red (r) and yellow (y) which, together with white (w) and black (k), define vertices of a tetrahedron 408 within the hexahedron 400 defined by all the selected colors 106. FIG. 4E shows the selection of green (g) and yellow (y) which, together with white (w) and black (k), define vertices of a tetrahedron 410 within the hexahedron 400 defined by all the selected colors 106. FIG. 4F shows the selection of blue (b) and magenta (m) which, together with white (w) and black (k), define vertices of a tetrahedron 412 within the hexahedron 400 defined by all the selected colors 106. The tetrahedra 402-412 are non-overlapping and may share faces.

With reference to FIG. 1, the instructions 102 may encode a source datapoint 120 as a mixture of white 110, black 112, and two selected chromatic colors 114, 116 as the primary and secondary colors, where a represent a proportional amount of white (w), black (k), primary (p), and secondary (s) in:

$$[ \begin{matrix}R \\ G \\ B\end{matrix} ] = {α}_{w} [ \begin{matrix}{R}_{w} \\ {G}_{w} \\ {B}_{w}\end{matrix} ] + {α}_{k} [ \begin{matrix}{R}_{k} \\ {G}_{k} \\ {B}_{k}\end{matrix} ] + {α}_{p} [ \begin{matrix}{R}_{p} \\ {G}_{p} \\ {B}_{p}\end{matrix} ] + {α}_{s} [ \begin{matrix}{R}_{s} \\ {G}_{s} \\ {B}_{s}\end{matrix} ] \qquad ( 1 )$$

As will be explained below, the selection of the primary and secondary colors may be based on the relative position in the source color space 122 of the source datapoint 120 relative to white, black, and the primary and secondary colors. That is, with reference to FIGS. 4A-4F, the source datapoint 120 may be determined to be within one of the tetrahedra 402-412 and thus the source datapoint 120 may be encoded as a mixture of the colors that define the vertices of that containing tetrahedron 402-412. Equivalently, the two primary and secondary colors may be determined based on a ranking of RGB color component values of the source datapoint 120.

For example, with reference to FIG. 4D, the RGB values of a source datapoint 120 landing within the tetrahedron 408 may be described as a mixture of the black, white, red, and yellow vertices, as follows:

$$[ \begin{matrix}R \\ G \\ B \\ 1\end{matrix} ] = {α}_{w} [ \begin{matrix}1 \\ 1 \\ 1 \\ 1\end{matrix} ] + {α}_{k} [ \begin{matrix}0 \\ 0 \\ 0 \\ 1\end{matrix} ] + {α}_{p} [ \begin{matrix}1 \\ 0 \\ 0 \\ 1\end{matrix} ] + {α}_{s} [ \begin{matrix}1 \\ 1 \\ 0 \\ 1\end{matrix} ] \qquad ( 2 )$$

$$or$$

$$[ \begin{matrix}R \\ G \\ B \\ 1\end{matrix} ] = [ \begin{matrix}1 & 0 & 1 & 1 \\ 1 & 0 & 0 & 1 \\ 1 & 0 & 0 & 0 \\ 1 & 1 & 1 & 1\end{matrix} ] [ \begin{matrix}{α}_{w} \\ {α}_{k} \\ {α}_{p} \\ {α}_{s}\end{matrix} ] . \qquad \text{(3)}$$

This may be inverted as:

$$[ \begin{matrix}{α}_{w} \\ {α}_{k} \\ {α}_{p} \\ {α}_{s}\end{matrix} ] = [ \begin{matrix}0 & 0 & 1 & 0 \\ - 1 & 0 & 0 & 1 \\ 1 & - 1 & 0 & 0 \\ 0 & 1 & - 1 & 0\end{matrix} ] [ \begin{matrix}R \\ G \\ B \\ 1\end{matrix} ] , \qquad ( 4 )$$

$$such that$$

$${α}_{w} = B , \qquad ( 5 a )$$

$${α}_{k} = 1 - R , \qquad ( 5 b )$$

$${α}_{p} = R - G , \qquad ( 5 c )$$

$${α}_{s} = G - B . \qquad \text{(5d)}$$

The same logic applies to all combinations of primary and secondary colors, as shown in FIGS. 4A-4F. As such, proportional amounts of white, black, the primary color, and the secondary color may be computed from red, green, and blue components, provided that the suitable primary and secondary colors are determined.

For a function in an RGB coordinate space f=f(R, G, B), if f_{w}=f(R_{w}, G_{w}, B_{w}), fₖ=(Rₖ, Gₖ, Bₖ), fₚ=(Rₚ, Gₚ, Bₚ), and fₛ=f(Rₛ, Gₛ, Bₛ) are known and the values of f inside the tetrahedron 402-412 defined by these four sets of color coordinates are unknown, these values may be approximated using linear interpolation. Barycentric coordinates may be used to express this computation:

f=α_{w}f_{w}+αₖfₖ+αₚfₚ+αₛfₛ. (6)

Further, if f is known for all the vertices of the RGB unit cube, f_{w}=f(1, 1, 1), fₖ=f(0, 0, 0), fᵣ=f(1, 0, 0), f_{g}=f(0, 1, 0), f_{b}=f(0, 0, 1), f_{c}=f(0, 1, 1), fₘ=f(1, 0, 1), and f_{y}=f(1, 1, 0), then f may be approximated over the entire space. To interpolate f at the RGB values of a source datapoint 120, first the tetrahedron 402-412 that contains the source datapoint 120 is found, after which the value of f can be interpolated as described above. To find the correct tetrahedron 402-412, the source datapoint 120 RGB values may be transformed into the barycentric coordinates of each tetrahedron 402-412. If a tetrahedron 402-412 is found such that the coordinates satisfy 0≤α_{w}≤1, 0≤αₖ≤1, 0≤αₚ≤1, and 0≤αₛ≤1, then the source datapoint 120 point lies within that tetrahedron 402-412. This procedure simplifies to a partitioning identified by six possible RGB ordinal patterns, as follows:

$$[ \begin{matrix}{α}_{w} & {α}_{k} & {α}_{p} & {α}_{s}\end{matrix} ] = \{ \begin{matrix}[ \begin{matrix}B & 1 - R & R - G & G - B\end{matrix} ] , R \geq G \geq B \\ [ \begin{matrix}G & 1 - R & R - B & B - G\end{matrix} ] , R \geq B \geq G \\ [ \begin{matrix}B & 1 - G & G - R & R - B\end{matrix} ] , G \geq R \geq B \\ [ \begin{matrix}G & 1 - B & B - R & R - G\end{matrix} ] , B \geq R \geq G \\ [ \begin{matrix}R & 1 - G & G - B & B - R\end{matrix} ] , G \geq B \geq R \\ [ \begin{matrix}R & 1 - B & R - G & G - R\end{matrix} ] , B \geq G \geq R\end{matrix} , \qquad ( 7 )$$

$$where$$

$$[ \begin{matrix}{f}_{w} & {f}_{k} & {f}_{p} & {f}_{s}\end{matrix} ] = \{ \begin{matrix}[ \begin{matrix}{f}_{w} & {f}_{k} & {f}_{r} & {f}_{y}\end{matrix} ] , R \geq G \geq B \\ [ \begin{matrix}{f}_{w} & {f}_{k} & {f}_{r} & {f}_{m}\end{matrix} ] , R \geq B \geq G \\ [ \begin{matrix}{f}_{w} & {f}_{k} & {f}_{g} & {f}_{y}\end{matrix} ] , G \geq R \geq B \\ [ \begin{matrix}{f}_{w} & {f}_{k} & {f}_{b} & {f}_{m}\end{matrix} ] , B \geq R \geq G \\ [ \begin{matrix}{f}_{w} & {f}_{k} & {f}_{g} & {f}_{c}\end{matrix} ] , G \geq B \geq R \\ [ \begin{matrix}{f}_{w} & {f}_{k} & {f}_{b} & {f}_{c}\end{matrix} ] , B \geq G \geq R\end{matrix} . \qquad \text{(8)}$$

Alternatively and equivalently, these calculations may be expressed according to a ranking of RGB components. For this purpose, an ordinal sorting of RGB components may be expressed as follows:

(r₀,r₁,r₂)=(R,G,B) (9)

(r_{λ},r_{μ},r_{ν})=sort(r₀,r₁,r₂) (10)

such that r_{λ}≤r_{μ}≤r_{ν}, where

(λ,μ,ν)=argsort(r₀,r₁,r₂). (11)

Using Equations (9) to (11), the barycentric coordinates of each of the six tetrahedra 402-412 may be expressed as α_{w}=r_{λ}, αₖ=1−r_{ν}, αₚ=r_{ν}−r_{μ}, and αₛ=r_{μ}−r_{λ}, such that Equations (6) to (8) may be reduced to the expression:

f=r_{λ}f_{w}+(1−r_{ν})fₖ+(r_{ν}−r_{μ})fₚ+(r_{μ}−r_{λ})fₛ. (12)

As such, given an RGB source datapoint 120 the relevant primary and secondary colors may be determined from the containing tetrahedra 402-412, or equivalently from the RGB component ranking, and proportional amounts of white (α_{w}), black (αₖ), a primary color (αₚ), and a secondary color (αₛ) may be computed. The forward transform may thus be completed by computing the reference datapoint 124 in the reference color space 108 as:

$$[ \begin{matrix}{L}^{*} \\ {a}^{*} \\ {b}^{*}\end{matrix} ] = {α}_{w} [ \begin{matrix}{L}_{w}^{*} \\ {a}_{w}^{*} \\ {b}_{w}^{*}\end{matrix} ] + {α}_{k} [ \begin{matrix}{L}_{k}^{*} \\ {a}_{k}^{*} \\ {b}_{k}^{*}\end{matrix} ] + {α}_{p} [ \begin{matrix}{L}_{p}^{*} \\ {a}_{p}^{*} \\ {b}_{p}^{*}\end{matrix} ] + {α}_{s} [ \begin{matrix}{L}_{s}^{*} \\ {a}_{s}^{*} \\ {b}_{s}^{*}\end{matrix} ] . \qquad ( 13 )$$

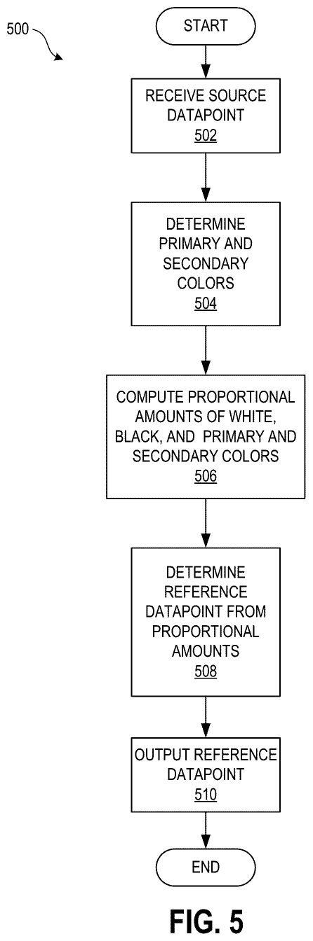

FIG. 5 shows an example method 500 to encode a source datapoint to obtain a reference datapoint with a color encoding that is based on selected colors including white, black, and a set of chromatic colors spanning a combined print gamut of a range of different printing devices. The method 500 may be implemented as processor-executable instructions. In this example, the selected colors are white, black, red, green, blue, cyan, magenta, and yellow.

At block 502, a source datapoint is received. The source datapoint may be member of a set of pixel data and may represent a single pixel. The source datapoint may be within a source color space that accords with an RGB color model.

At block 504, two colors, termed primary and secondary, are determined. The primary and secondary colors are used with white and black to encode the source datapoint. The primary and secondary colors are selected based on the source datapoint from the chromatic colors that define the color encoding. The color component values of the source datapoint may be ranked and the primary and secondary colors may be selected based on the ranking, as discussed above with regard to Equations (9)-(12). Alternatively, the primary and secondary colors may be determined as the two chromatic colors that, with white and black, define a volume within the source color space that contains the source datapoint, as discussed above with regard to FIGS. 4A-4F. The volume may be a tetrahedron within a hexahedron having vertices defined by the selected colors of the color encoding in the source color space, which hexahedron may manifest as a corresponding reference polyhedron in the reference color space.

At block 506, the proportional amounts of white, black, and the primary and secondary colors selected at block 504 may be determined for the source datapoint. Linear interpolation may be used to determine the proportional amounts. This may apply Equation (7) or (12) above, for example.

At block 508, the source datapoint is encoded by determining the reference datapoint in the reference color space as the mixture of white, black, and the primary and secondary colors based on the proportional amounts from block 506. Equation (13) may be applied. The reference datapoint may be expressed as an L*a*b* triplet in a CIELAB color space.

At block 510, the reference datapoint is outputted. The reference datapoint may be member of a set of pixel data that is outputted to a printer device for reproduction or to a computing device for storage, manipulation, or communication.

Note that blocks 504-508 are shown and described as discrete actions for sake of explanation. In various implementations, various actions may be carried out simultaneously and/or by the same computation.

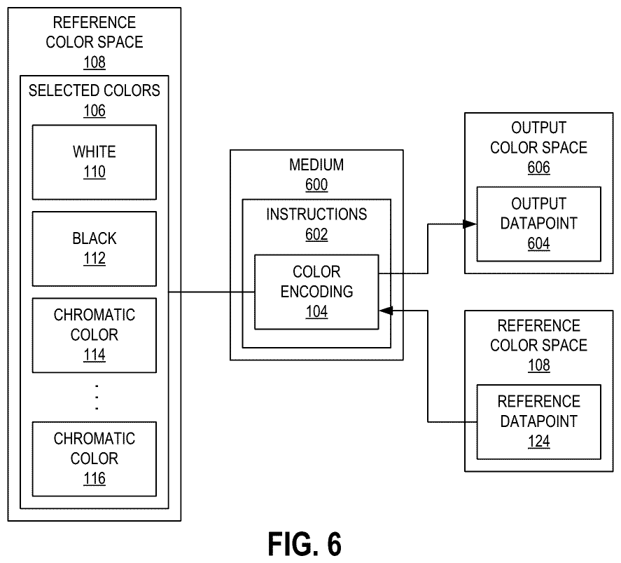

FIG. 6 shows an example non-transitory machine-readable medium 600 including processor-executable instructions 602 that define a color encoding 104 based on selected colors 106 within a reference color space 108.

The non-transitory machine-readable medium 600 may be provided to a computing device, such as a desktop computer, notebook computer, AiO computer, server, tablet computer, smartphone, or the like. The medium 600 may be similar or identical to the medium 100 discussed above.

The discussion above for the medium 100 may be referenced for detail not repeated here concerning the color encoding 104, selected colors 106, reference color space 108, and other components sharing like reference numerals and/or like terminology.

The instructions 602 encode a reference datapoint 124 of the reference color space 108 with the color encoding 104 to obtain an output datapoint 604 of an output color space 606 by determining the output datapoint 604 as a mixture of white 110 or black 112, and two colors selected from the set of chromatic colors 114, 116. Encoding from the reference color space 108 to the output color space 606 may be considered a reverse transform that complements the forward transform discussed with respect to FIG. 1.

As mentioned above, the reference color space 108 may be a CIELAB color space or other standard color space. The reference datapoint 124 may be encoded as a triplet of lightness value, L*, and two opponent color values, a* and b*.

The output color space 606 may be a display-device color space, such as an RGB color space that is directly consumed by a display device. The output datapoint 604 may be encoded as a red, green, and blue triplet with values, for example, from 0 to 255. Any number of output datapoints 604 may be encoded, such as a set of datapoints that represent pixels of a digital image. The output color space 606 may be the same as the source color space 122 discussed with respect to FIG. 1.

The instructions 602 further output the output datapoint 604, for example, as part of a digital image.

In various examples, the instructions 602 and instructions 102 (FIG. 1) are provided to the same non-transitory machine-readable medium, so that both the forward and reverse transform may be performed by the same processor as needed.

The reverse transform may convert a L*a*b* reference datapoint 124 to a respective RGB output datapoint 604 to using linear interpolation, as follows.

The reference datapoint 124 may be described as a linear combination of four of the selected colors 106. For example, the same four colors from the forward transform may be used in the reverse transform, namely white 110, black 112, one of the red-green-blue primary colors, and one of the cyan-magenta-yellow secondary colors.

The reference datapoint 124 may be described as a mixture, as follows:

$$[ \begin{matrix}{L}^{*} \\ {a}^{*} \\ {b}^{*} \\ 1\end{matrix} ] = {α}_{w} [ \begin{matrix}{L}_{w}^{*} \\ {a}_{w}^{*} \\ {b}_{w}^{*} \\ 1\end{matrix} ] + {α}_{k} [ \begin{matrix}{L}_{k}^{*} \\ {a}_{k}^{*} \\ {b}_{k}^{*} \\ 1\end{matrix} ] + {α}_{p} [ \begin{matrix}{L}_{p}^{*} \\ {a}_{p}^{*} \\ {b}_{p}^{*} \\ 1\end{matrix} ] + {α}_{s} [ \begin{matrix}{L}_{s}^{*} \\ {a}_{s}^{*} \\ {b}_{s}^{*} \\ 1\end{matrix} ] \qquad ( 14 )$$

White and black are common to all six tetrahedra 402-412 (FIGS. 4A-4F), thus, with reference to Tables 1 and 2, Equation (14) can be rewritten as:

$$[ \begin{matrix}{L}^{*} \\ {a}^{*} \\ {b}^{*} \\ 1\end{matrix} ] = {α}_{w} [ \begin{matrix}{L}_{w}^{*} \\ 0 \\ 0 \\ 1\end{matrix} ] + {α}_{k} [ \begin{matrix}{L}_{k}^{*} \\ 0 \\ 0 \\ 1\end{matrix} ] + {α}_{p} [ \begin{matrix}{L}_{p}^{*} \\ {a}_{p}^{*} \\ {b}_{p}^{*} \\ 1\end{matrix} ] + {α}_{s} [ \begin{matrix}{L}_{s}^{*} \\ {a}_{s}^{*} \\ {b}_{s}^{*} \\ 1\end{matrix} ] \qquad ( 15 )$$

Further, by defining the following:

$${L}^{* ′} = \frac{{L}^{*} - {L}_{k}^{*}}{{L}_{w}^{*} - {L}_{k}^{*}} \qquad ( 16 a )$$

$${L}_{p}^{* ′} = \frac{{L}_{p}^{*} - {L}_{k}^{*}}{{L}_{w}^{*} - {L}_{k}^{*}} \qquad ( 16 a )$$

$${L}_{s}^{* ′} = \frac{{L}_{s}^{*} - {L}_{k}^{*}}{{L}_{w}^{*} - {L}_{k}^{*}} \qquad \text{(16a)}$$

Equation (15) can be written as:

$$[ \begin{matrix}{L}^{* ′} \\ {a}^{*} \\ {b}^{*} \\ 1\end{matrix} ] = {α}_{w} [ \begin{matrix}1 \\ 0 \\ 0 \\ 1\end{matrix} ] + {α}_{k} [ \begin{matrix}0 \\ 0 \\ 0 \\ 1\end{matrix} ] + {α}_{p} [ \begin{matrix}{L}_{p}^{* ′} \\ {a}_{p}^{*} \\ {b}_{p}^{*} \\ 1\end{matrix} ] + {α}_{s} [ \begin{matrix}{L}_{s}^{* ′} \\ {a}_{s}^{*} \\ {b}_{s}^{*} \\ 1\end{matrix} ] \qquad ( 17 )$$

$$or$$

$$[ \begin{matrix}{L}^{* ′} \\ {a}^{*} \\ {b}^{*} \\ 1\end{matrix} ] = [ \begin{matrix}1 & 0 & {L}_{p}^{* ′} & {L}_{s}^{* ′} \\ 0 & 0 & {a}_{p}^{*} & {a}_{s}^{*} \\ 0 & 0 & {b}_{p}^{*} & {b}_{s}^{*} \\ 1 & 1 & 1 & 1\end{matrix} ] [ \begin{matrix}{α}_{w} \\ {α}_{k} \\ {α}_{p} \\ {α}_{s}\end{matrix} ] . \qquad ( 18 )$$

Thus, the reverse transform may be expressed as follows:

$$[ \begin{matrix}{α}_{w} \\ {α}_{k} \\ {α}_{p} \\ {α}_{s}\end{matrix} ] = \frac{1}{{K}_{ab}} [ \begin{matrix}{K}_{ab} & - {K}_{Lb} & {K}_{La} & 0 \\ - {K}_{ab} & {b}_{s}^{*} - {b}_{p}^{*} + {K}_{Lb} & {a}_{p}^{*} - {a}_{s}^{*} - {K}_{La} & {K}_{ab} \\ 0 & - {b}_{s}^{*} & {a}_{s}^{*} & 0 \\ 0 & {b}_{p}^{*} & - {a}_{p}^{*} & 0\end{matrix} ] [ \begin{matrix}{L}^{* ′} \\ {a}^{*} \\ {b}^{*} \\ 1\end{matrix} ] , \qquad ( 19 )$$

$$such that$$

$${α}_{w} = {L}^{* ′} - {a}^{*} \frac{{K}_{Lb}}{{K}_{ab}} + {b}^{*} \frac{{K}_{La}}{{K}_{ab}} , \qquad ( 20 a )$$

$${α}_{p} = - \frac{{a}^{*} {b}_{s}^{*}}{{K}_{ab}} + \frac{{b}^{*} {a}_{s}^{*}}{{K}_{ab}} , \qquad ( 20 b )$$

$${α}_{s} = \frac{{a}^{*} {b}_{p}^{*}}{{K}_{ab}} - \frac{{b}^{*} {a}_{p}^{*}}{{K}_{ab}} , \qquad ( 20 c )$$

$${α}_{k} = 1 - {α}_{w} - {α}_{p} - {α}_{s} . \qquad ( 20 d )$$

$${K}_{ab} = \vert \begin{matrix}{a}_{s}^{*} & {a}_{p}^{*} \\ {b}_{s}^{*} & {b}_{p}^{*}\end{matrix} \vert = {a}_{s}^{*} {b}_{p}^{*} - {a}_{p}^{*} {b}_{s}^{*} , \qquad \text{(21a)}$$

$${K}_{La} = \vert \begin{matrix}{L}_{s}^{* ′} & {L}_{p}^{* ′} \\ {a}_{s}^{*} & {a}_{p}^{*}\end{matrix} \vert = {L}_{s}^{* ′} {a}_{p}^{*} - {L}_{p}^{* ′} {a}_{s}^{*} , \qquad ( 21 b )$$

$${K}_{Lb} = \vert \begin{matrix}{L}_{s}^{* ′} & {L}_{p}^{* ′} \\ {b}_{s}^{*} & {b}_{p}^{*}\end{matrix} \vert = {L}_{s}^{* ′} {b}_{p}^{*} - {L}_{p}^{* ′} {b}_{s}^{*} . \qquad ( 21 c )$$

With regard to Equations (9) to (12), RGB values may be computed directly from these barycentric coordinates provided that the correct tetrahedron 402-412 is selected:

r_{λ}=α_{w}, (20a)

r_{μ}=α_{w}+αₛ, (20b)

r_{ν}=α_{w}+αₚ+αₛ. (20c)

A hue angle of the point (L*, a*, b*) in the context of the partitioning described by Tables 1 and 2 may be used to determine the correct tetrahedron 402-412 where:

$$h ° = atan 2 ( {b}^{*} , {a}^{*} ) , \qquad ( 21 )$$

$$( {r}_{λ} , {r}_{μ} , {r}_{v} ) = \{ \begin{matrix}( G , B , R ) , 0. \leq h ° \leq 37.0878 \\ ( B , G , R ) , 37.0878 \leq h ° \leq 96.164 \\ ( B , R , G ) , 96.164 \leq h ° \leq 159.2955 \\ ( R , B , G ) , 159.2955 \leq h ° \leq 221.1857 \\ ( R , G , B ) , 221.1857 \leq h ° \leq 296.096 \\ ( G , R , B ) , 296.096 \leq h ° \leq 339.444 \\ ( G , B , R ) , 339.444 \leq h ° \leq 360.\end{matrix} . \qquad \text{(22)}$$

Thus, once the proportional amounts of white (α_{w}), black (αₖ), a primary color (αₚ), and a secondary color (αₛ) are computed using Equations (20)-(22), the RGB components of the output datapoint 604 may be computed using Equation (1) above.

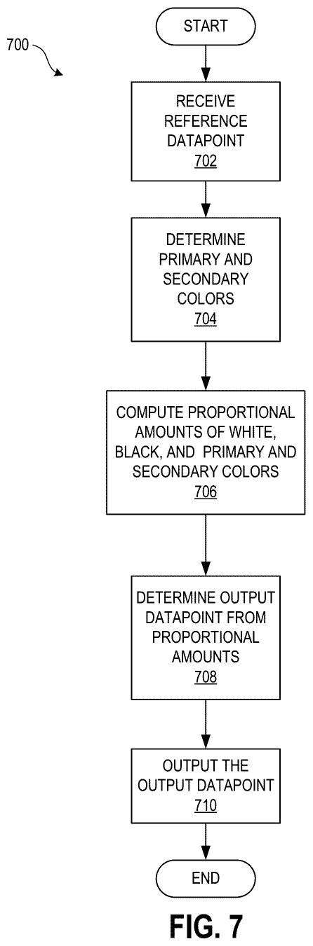

FIG. 7 shows an example method 700 to encode a reference datapoint to obtain an output datapoint with a color encoding that is based on selected colors including white, black, and a set of chromatic colors spanning a combined print gamut of a range of different printing devices. The method 700 may be implemented as processor-executable instructions. In this example, the selected colors are white, black, red, green, blue, cyan, magenta, and yellow.

At block 702, a reference datapoint is received. The reference datapoint may be member of a set of pixel data and may represent a single pixel. The reference datapoint may be within a reference color space, such as a CIELAB color space.

At block 704, two colors, termed primary and secondary, are determined. The primary and secondary colors are used with white and/or black to encode the reference datapoint. The primary and secondary colors are selected based on the reference datapoint from the chromatic colors defining the color encoding. The primary and secondary colors may be selected based on a hue angle of the reference datapoint, as discussed above with regard to Equations (21) and (22). Other methodologies may be used to determine the primary and secondary colors as the two chromatic colors that, with white and black, define a volume within the reference color space that contains the reference datapoint (i.e., analogous to FIGS. 4A-4F). The volume may be a sub-volume of a reference polyhedron in the reference color space.

At block 706, the proportional amounts of white, black, and the primary and secondary colors selected at block 704 may be determined for the reference datapoint. This may apply Equations (20) above, for example.

At block 708, the output datapoint is encoded by determining the output datapoint in the output color space as the mixture of white, black, and the primary and secondary colors based on the proportional amounts from block 706. Equation (1) may be applied. The output datapoint may be expressed as RGB triplet in an RGB color space.

At block 710, the output datapoint is outputted. The output datapoint may be member of a set of pixel data that is outputted to a display device for display.

Note that blocks 704-708 are shown and described as discrete actions for sake of explanation. In various implementations, various actions may be carried out simultaneously and/or by the same computation.

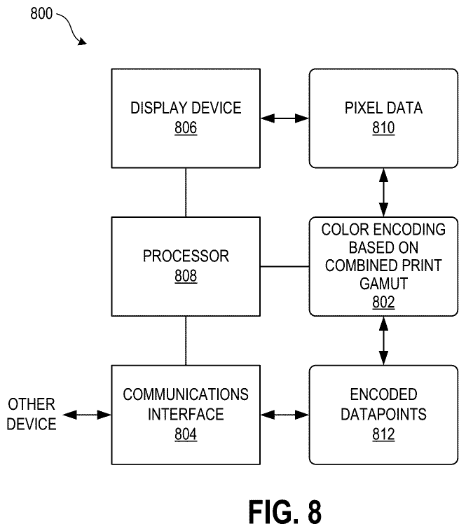

FIG. 8 is block diagram of an example computing device 800 that includes a processor to apply a color encoding 802 based on selected colors that span a combined print gamut of a range of different printing devices. The computing device 800 may be a desktop computer, notebook computer, All-in-One (AiO) computer, server, tablet computer, smartphone, or the like.

The computing device 800 includes a communications interface 804, a display device 806, and a processor 808 connected to the communications interface 804 and the display device 806.

The communications interface 804 may include a serial port, parallel port, network adaptor, or similar device capable of communicating data with another device, such as a printer. The communications interface 804 may be wired or wireless. The communications interface 804 may be a direct point-to-point interface, such as a universal serial bus (USB)™ interface, or may be a network interface, such as a wireless network adaptor and driver.

The display device 806 may include a light-emitting diode (LED) display, liquid-crystal display (LCD), or similar device capable of displaying a digital image formed of an array of pixels. The display device 806 may include a touchscreen.

The processor 808 may include a CPU or other kind of processor (examples discussed above) capable of executing instructions that implement the functionality discussed herein.

The color encoding 802 is defined by selected colors within a reference color space. The selected colors 802 fit a combined print gamut of a range of different printing devices. For example, the selected colors may be specifically chosen to define a polyhedron within the reference color space, such that each face of the polyhedron fits a corresponding apparent surface of the combined print gamut. In this way, the selected colors 802 may define a gamut that encompasses the combined print gamut and that is shaped like the combined print gamut (see FIGS. 2 and 3). The combined print gamut may be empirically determined, such as by printing a test image and capturing color information from the test image under control conditions.

In an example forward transform, processor 808 encodes pixel data 810 displayed at the display device 806 with the color encoding 802 to obtain a set of encoded datapoints 812 by determining each encoded datapoint as a mixture of the selected colors that define the color encoding 802. The techniques discussed elsewhere herein may be used.

As such, a first set of pixel data 810 (i.e., an image) may be created or manipulated by the computing device 800, such as with an image capture device, image manipulation program, or productivity program. The first set of pixel data 810 may then be transformed into a corresponding first set of encoded datapoints 812 that matches the combined print gamut. The first set of encoded datapoints 812 may be outputted to a printing device via the communications interface 804. Having been encoded with the color encoding 802, the first set of encoded datapoints 812 is thus more likely provide expected color reproduction provided that the printer is or is similar to a member of the range of printers used to establish the combined print gamut. Further, the color encoding 802 or a representation thereof may also be provided to the printing device, for example, as an International Color Consortium (ICC) profile.

In an example reverse transform, the processor 808 encodes encoded datapoints 812 received at the communications interface 804 with the color encoding 802 to obtain a set of pixel data 810 by determining each pixel to be a mixture of the selected colors of the color encoding 802. The set of pixel data 810 may be outputted to the display device 806 for display.

As such, a second set of encoded datapoints 812 may be received, for example, from another computing device, and then converted to a second set of pixel data 810 suitable for display at the display device 806.

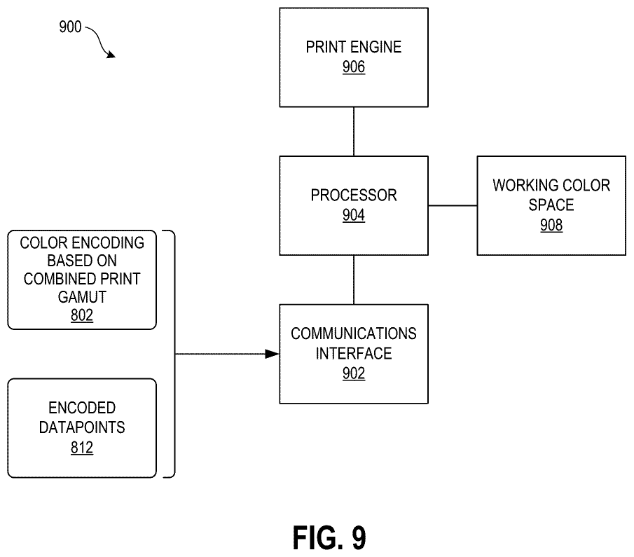

FIG. 9 shows an example printing device 900 to receive encoded datapoints 812 and a corresponding color encoding 802 based on selected colors that span a combined print gamut of a range of different printing devices.

The printing device 900 includes a communications interface 902 and a processor 904 connected to the communications interface 902. The printing device 900 may include a print engine 906 connected to the processor 904. An example of a printing device 900 that includes a print engine 906 is an office or home printer, such as an inkjet printer or laser printer. An example of a printing device 900 that may omit a print engine 906 is a print service computing device that processes images into files configured for printing.

The communications interface 902 may include a serial port, parallel port, network adaptor, or similar device capable of communicating data with another device, such as a computing device. The communications interface 902 may be wired or wireless. The communications interface 902 may be a direct point-to-point interface, such as a USB™ interface, or may be a network interface, such as a wireless network adaptor and driver.

The processor 904 may include a CPU or other kind of processor (examples discussed above) capable of executing instructions that implement the functionality discussed herein.

The print engine 906 includes an electromechanical apparatus to apply print agent, such as ink or toner, to print media, such as paper.

The communications interface 902 may receive encoded datapoints 812 encoded by the color encoding 802 (e.g., from a computing device 800 of FIG. 8), as well as the color encoding 802 itself (e.g., as an ICC profile). The processor 904 may process the encoded datapoints 812 with reference to the color encoding 802 and a working color space 908 native to the printing device 900 to obtain a set of print-ready datapoints, which may be printed by the print engine 906 or communicated to another printing device that contains a print engine 906.

In other examples, the printing device 900 may store the color encoding 802 in conjunction with its working color space 908 in a form that allows the processor 904 to convert pixel data 810 to the working color space 908. Hence, pixel data (e.g., an RGB image) may be received by the communications interface 902 and the printing device 900 may convert the pixel data into its working color space 908. That is, for example, the printing device 900 converts sRGB data into data encoded by the color encoding 802 and converts such data into the working color space 908 (e.g., CMYK).

In view of the above, it should be apparent that a printer (subtractive) shaped reference medium gamut may be described using an RGB color encoding and may be used to encompass a range of different printing devices. This may allow a wide range of different printing devices that serve different users and use-cases to reproduce color with the same or similar results. Consistent and expected color among different computing and printing devices may be realized without the need for specialized knowledge and training.

Further, the example color encoding described by Tables 1 and 2 was found to be efficient when compared to an example reference printer data set. The example reference printer data set had a gamut volume of 827,089. The example color encoding described by Tables 1 and 2 has a gamut volume of 948,153. This represents an encoding efficiency of about 87% (827,089/948,153).

Further, as the number of possible input color spaces increases (e.g., sRGB, Adobe™ RGB, Digital Cinema Initiative or DCI-P3, SWOP or Specifications for Web Offset Publications, etc.) the techniques described herein provide simplicity, efficiency, and consistency when compared to ad hoc custom color management for the likewise increasing number of combinations of printer-and-input color space.

It should be recognized that features and aspects of the various examples provided above can be combined into further examples that also fall within the scope of the present disclosure. In addition, the figures are not to scale and may have size and shape exaggerated for illustrative purposes.

1. A non-transitory machine-readable medium comprising instructions that, when executed by a processor, cause the processor to:
define a color encoding based on selected colors within a reference color space, the selected colors including white, black, and a set of chromatic colors spanning different print gamuts of a range of different printing devices;
encode a source datapoint of a source color space with the color encoding to obtain a reference datapoint of the reference color space by determining the reference datapoint as a mixture of white, black, and two colors selected from the set of chromatic colors; and
output the reference datapoint.

2. The non-transitory machine-readable medium of claim 1, wherein the instructions are further to cause the processor to select the two colors from the set of chromatic colors based on the source datapoint.

3. The non-transitory machine-readable medium of claim 2, wherein the instructions are further to select the two colors from the set of chromatic colors based on a ranking of color component values of the source datapoint.

4. The non-transitory machine-readable medium of claim 2, wherein the instructions are further to select the two colors to, with white and black, define a volume within the source color space that contains the source datapoint.

5. The non-transitory machine-readable medium of claim 4, wherein the volume is a tetrahedron within a hexahedron having vertices at the selected colors.

6. The non-transitory machine-readable medium of claim 1, wherein:
the selected colors define a hexahedron within the source color space;
the selected colors define a reference polyhedron, corresponding to the hexahedron, within the reference color space; and
the selected colors are positioned within the reference color space to position each face of the reference polyhedron adjacent to a corresponding apparent surface of a combined print gamut of the range of different printing devices.

7. The non-transitory machine-readable medium of claim 1, wherein the instructions are further to cause the processor to:
compute the reference datapoint as a linear combination in the reference color space of white, black, and the two colors selected from the set of chromatic colors according to a relative position in the source color space of the source datapoint relative to white, black, and the two colors selected from the set of chromatic colors; and
express the reference datapoint according to a color model of the reference color space.

8. The non-transitory machine-readable medium of claim 1, wherein:
the selected colors number eight; and
the set of chromatic colors include red, green, blue, cyan, magenta, and yellow.

9. A computing device including the non-transitory machine-readable medium of claim 1.

10. A non-transitory machine-readable medium comprising instructions that, when executed by a processor, cause the processor to:
define a color encoding based on selected colors within a reference color space, the selected colors including white, black, and a set of chromatic colors spanning different print gamuts of a range of different printing devices;
encode a reference datapoint of the reference color space with the color encoding to obtain an output datapoint of an output color space by determining the output datapoint as a mixture of white or black, and two colors selected from the set of chromatic colors; and
output the output datapoint.

11. The non-transitory machine-readable medium of claim 10, wherein the instructions are further to cause the processor to select the two colors from the set of chromatic colors based on the reference datapoint.

12. The non-transitory machine-readable medium of claim 11, wherein the instructions are further to cause the processor to select the two colors based on a hue angle of the reference datapoint.

13. The non-transitory machine-readable medium of claim 10, wherein the instructions are further to select the two colors to, with white and black, define a volume within the reference color space that contains the reference datapoint.

14. A computing device including the non-transitory machine-readable medium of claim 10.

15. A computing device comprising:
a communications interface;
a display device; and
a processor connected to the communications interface and the display device, the processor to:
encode a first set of pixel data displayed at the display device with a color encoding to obtain a first set of encoded datapoints, wherein the color encoding is defined by selected colors within a reference color space by determining each datapoint of the first set of encoded datapoints as a mixture of the selected colors, the selected colors fitting a combined print gamut of a range of different printing devices; and
output the first set of encoded datapoints to a printing device via the communications interface.

16. The computing device of claim 15, wherein the processor is further to:
encode a second set of encoded datapoints of the reference color space with the color encoding to obtain a second set of pixel data by determining each pixel of the second set of pixel data as a mixture of the selected colors of the color encoding; and
output the second set of pixel data to the display device.

17. The computing device of claim 15, wherein the printing device is to encode the first set of encoded datapoints with reference to the color encoding and a working color space native to the printing device to obtain a set of print-ready datapoints.

18. The computing device of claim 15, wherein the combined print gamut of a range of different printing devices is empirically determined.

19. The computing device of claim 15, wherein:
the selected colors are selected to define a polyhedron within the reference color space; and
the selected colors are selected to fit each face of the polyhedron to a corresponding apparent surface of the combined print gamut.

20. The computing device of claim 15, wherein the selected colors include white, black, red, green, blue, cyan, magenta, and yellow.
